(19) United States
(12) Patent Application Publication
(10) Pub. No.: US 2014/0085241 A1
(43) Pub. Date: Mar. 27, 2014

(54) DEVICE AND METHOD FOR DETERMINING REDUCED PERFORMANCE OF A TOUCH SENSITIVE APPARATUS

(71) Applicants: Tomas Christiansson, Torna-Hallestad (SE); Peter Juhlin, Lund (SE); Mats-Petter Wallander, Lund (SE); Ola Wassvik, Brosarp (SE)

(72) Inventors: Tomas Christiansson, Torna-Hallestad (SE); Peter Juhlin, Lund (SE); Mats-Petter Wallander, Lund (SE); Ola Wassvik, Brosarp (SE)

(73) Assignee: FLATFROG LABORATORIES AB, Lund (SE)

(21) Appl. No.: 14/111,951

(22) PCT Filed: May 14, 2012
(86) PCT No.: PCT/SE12/50509

§ 371 Date: Dec. 12, 2013

Related U.S. Application Data
(60) Provisional application No. 61/486,378, filed on May 16, 2011.

(30) Foreign Application Priority Data
May 16, 2011 (SE) 1150446-1

(51) Int. Cl. G06F 3/041

(52) U.S. Cl. CPC G06F 3/041
USPC 345/173

(57) ABSTRACT

A device for processing data from a touch sensitive apparatus is provided. The apparatus includes a light transmitting panel with a touch surface and an opposed back surface, an illumination arrangement configured to introduce light into the panel for propagation by internal reflection between the touch surface and the back surface, and a light detection arrangement configured to receive the light after propagation in the panel. A processor unit in the device obtains a monitored signal which is functionally dependent on transmitted light detected by the light detection arrangement; reconstructs, based on the monitored signal, a two-dimensional attenuation field representing an attenuation of the transmitted light on the touch surface; calculates an expected monitored signal based on the reconstructed attenuation field; and compares the expected monitored signal with the monitored signal in order to determine a reduced performance of the apparatus.

### CROSS-REFERENCE TO RELATED APPLICATIONS

The present application claims the benefit of Swedish patent application No. 1150446-1, filed on May 16, 2011, and U.S. provisional application No. 61/486,378, filed on May 16, 2011, both of which are incorporated herein by reference.

### TECHNICAL FIELD

The invention relates to techniques for detecting the interaction between an object and a panel of a touch sensitive apparatus. The invention is directed at identifying a reduced performance in a touch sensitive apparatus. In particular, the invention relates to a device for processing data from a touch sensitive apparatus, a touch sensitive apparatus in itself, a method of determining a reduced performance in a touch sensitive apparatus, a method of processing data from a touch sensitive apparatus, and a computer-readable medium storing processing instructions for performing either of said methods.

### BACKGROUND ART

To an increasing extent, touch-sensitive panels are being used for providing input data to computers, cell phones, electronic measurement and test equipment, gaming devices, etc. The panel may be provided with a graphical user interface (GUI) for a user to interact with using e.g. a pointer, stylus or one or more fingers.

There are numerous known techniques for providing touch sensitivity to the panel for purpose of detecting interaction between a touching object and the panel, e.g. by using cameras to capture light scattered off the point(s) of touch on the panel, or by incorporating resistive wire grids, capacitive sensors, strain gauges, etc. into the panel. These techniques are all dependent on the well-functioning of the technical components of the touch detection system. If some components, such as light emitters and light detectors, degrade or fail the panels would exhibit a gradual or even total loss of capability of accurately identifying touches.

This problem is addressed in U.S. Pat. No. 4,635,920, where a method of detecting faults in a so called opto-matrix touch input device is described. In this device, light beams are propagated above a touch surface from a large number of different directions between emitters and detectors arranged around the periphery of the touch surface. An object such as a finger or a stylus that touches the touch surface will block certain light beams. By processing the output of the detectors, the system determines the location of the touching object. Further, detector readings of the received light from different emitters are compared to an ambient reading corresponding to the received light from the ambient light when no emitters are activated. If the difference between the readings exceed a first or second threshold level (CON1 or CON2), the corresponding beam is determined as a “bad beam” or a “marginal beam”, respectively, i.e. a defect status caused by a defect component in the touch apparatus.

U.S. Pat. No. 7,432,893 discloses an alternative touch-sensing technique which is based on frustrated total internal reflection (FTIR). Diverging beams from two spaced-apart light sources are coupled into a panel to propagate inside the panel by total internal reflection. The light from each light source is evenly distributed throughout the entire panel. Arrays of light sensors are located around the perimeter of the panel to detect the light from the light sources. When an object comes into contact with a surface of the panel, the light will be locally attenuated at the point of touch. The interaction between the object and the panel is determined by triangulation based on the attenuation of the light from each source at the array of light sensors.

Other types of touch-sensing techniques based on FTIR are known from inter alia U.S. Pat. No. 3,673,327, US2006/0114237, US2007/0075648, U.S. Pat. No. 6,972,753, US2010/0193259, WO2010/006882, WO2010/006883, WO2010/006884, WO2010/006885, WO 2010/006886 and WO2010/134865.

Further, WO2010/015409 discloses an FTIR system, which is designed to control the power of individual emitters so as to maintain the signal-to-noise ratio of a detected signal above a predetermined maximum value. This is done in order to minimize quantization noise of a downstream ADC (Analog-Digital-Converter) by matching the dynamic range of the integrated output to the input range of the ADC.

WO2009/077962 discloses a touch screen in the form of a panel using a “tomograph” that comprises signal flow ports. The tomograph processes signals introduced into the panel and detects changes in the signals caused by touches on the touch screen. The touch-sensing technique may be based on FTIR. Specifically, signals measured at the signal flow ports are “tomographically processed” to generate a two-dimensional representation of the “conductivity” on the panel, whereby touching objects on the panel surface may be detected and shown on a display.

None of these prior art documents present a technique that enables an evaluation of the well-functioning of a touch sensitive apparatus as it is being used.

### SUMMARY

It is an object of the invention to provide a touch-sensing apparatus and a corresponding method, which have an improved reliability with respect to the prior art, and in particular with improved capability of detecting faults. In particular, it is an object to provide a touch-sensitive apparatus that is capable of determining touches on a panel while simultaneously detecting degradation or failure of components of the apparatus.

According to a first aspect, the invention relates to a device for processing data from a touch sensitive apparatus, which apparatus comprises: a light transmitting panel, which is defined by a touch surface on one side and by an opposed back surface on the opposite side; an illumination arrangement configured to introduce light into the panel for propagation by internal reflection between the touch surface and the back surface; a light detection arrangement configured to receive the light after propagation in the panel, wherein the device comprises a processor unit configured to: obtain a monitored signal which is functionally dependent on transmitted light detected by the detection arrangement, reconstruct, based on the monitored signal, a two-dimensional attenuation field representing an attenuation of the transmitted light on the touch surface, calculate an expected monitored signal based on the reconstructed attenuation field, and compare the expected monitored signal with the monitored signal in order to determine a reduced performance of the apparatus.

The first aspect is based on the insight that fault detection may be based on the reconstructed two-dimensional attenuation field, specifically based on an expected monitored signal which is calculated by doing the reconstruction “backwards” on the two-dimensional attenuation field. It has been found that touch-related signal features in the monitored signal are also present in the expected monitored signal, whereas fault-related signal features are suppressed in the expected monitored signal. It is realized that the well-functioning of the apparatus may be assessed by comparing the expected monitored signal with the monitored signal.

The attenuation field may also be processed for detection of touches on the panel, thereby enabling simultaneous touch determination and fault detection. Corresponding advantages may be obtained by combining the inventive fault detection with other ways of determining touches based on the monitored signal or based on another signal that represents the transmitted light detected by the light detection arrangement.

The propagation by internal reflection between the touch surface and the opposite back surface may be in the form of total internal reflection, and the attenuation of the light when the object touches the touch surface can involve FTIR. The back surface may be an external or internal surface of the panel.

It should be noted that several suitable techniques for introducing light in the panel as well as techniques for receiving the light exist, which includes a possibility to introduce and receive the light at a number of different light incoupling sites and light outcoupling sites at e.g. an edge of the panel or at an upper or at a lower surface of the panel.

In one embodiment, as long as the device is in an operative mode, the light is continuously introduced by the illumination arrangement while the light detection arrangement continuously receives the light and generates the signal. Every concluded generating of a signal corresponds to a sensing instance. Simultaneously, the processor unit may process the current signal values of the monitored signal, determine the reduced performance and determine the location of one or more touches on the touch surface. Alternatively, the steps involved for determining the reduced performance are only performed during selected sensing instances, such as e.g. once every 10, 100 or 1 000 sensing instances.

Moreover, obtaining a monitored signal which is functionally dependent on transmitted light may be done in numerous ways and may include any operation for acquiring data from a light-detecting device. Typically, the monitored signal reflects not only energy or power of light received by the light detection arrangement, but also noise that for some reason may be caused by a component of the device. The monitored signal must not necessarily be a raw-signal of the light detection arrangement but may be any signal derived there from, such as a normalized signal and/or a signal representing attenuation of transmitted light.

The reduced performance may comprise a gradual lowering of light output from the illumination arrangement or a gradually decreased capability of detecting light by the light detection arrangement. The reduced performance may also comprise complete breakdown of any of the illumination arrangement and the light detection arrangement or breakdown of only a part thereof, such as breakdown of a certain light emitter or light detector. Moreover, “reduced performance” may be interpreted as any reduction in the light emitting performance of the illumination arrangement and/or any reduction in light detecting performance of the light detection arrangement, where the reduction typically is a deviation from a desired performance. Such a deviation may occur e.g. if some parts of the illumination arrangement or light detection arrangement is intended to be attached to the panel but comes loose. Examples of such parts include structures for coupling the light into or out of the panel.

As further explained below, the processor unit may be configured to employ numerous known techniques for reconstructing the 2D attenuation field across the touch surface, or part thereof, such as tomography based techniques, e.g. using a raw signal of the light detection arrangement or a signal derived there from as input.

The processor unit may be configured to reconstruct the attenuation field based on a grid of detection lines that each represents a path of light across the touch surface from the illumination arrangement to the light detection arrangement, wherein the monitored signal may be comprised of a number of monitored sub-signals with a respective signal value that is functionally dependent on a measured light energy of a corresponding detection line, and wherein the attenuation field is reconstructed on basis of the signal values of the monitored sub-signals.

The processor unit may be configured to reconstruct the attenuation field by tomographic reconstruction based on the signal values of the monitored sub-signals.

Further, the processor unit may be configured to calculate the expected monitored signal by evaluating a projection function that estimates an aggregated attenuation for at least part of the detection lines.

The processor unit may be configured to calculate expected sub-signals for at least part of the detection lines based on the reconstructed attenuation field.

In one embodiment, the attenuation field is defined by a set of basis functions on the touch surface and a reconstructed attenuation value for each basis function, and the processor unit is configured to calculate the expected sub-signals for at least part of the detection lines as a function of an intersection between the detection line and the basis functions.

Further the processor unit may be configured to compare each expected sub-signal to the corresponding monitored sub-signal.

The processor unit may also be configured to produce a comparative sub-signal based on the comparison between the reconstructed sub-signals and the monitored sub-signals, and further the processor unit may be configured to alert if the comparative sub-signal passes (i.e. falls above and/or below, depending on implementation) a predetermined threshold value.

The processor unit may be configured to group specific components of the illumination arrangement and/or the light detection arrangement to specific comparative sub-signals in order to link a reduced performance to a specific component.

Also, the processor unit may be configured to, if the reduced performance is linked to a specific component, disregard monitored sub-signals linked to the specific component in subsequent reconstructions of the attenuation field.

For instance, the processor unit may be configured to disregard monitored sub-signals linked to the specific component only after the same reduced performance has been determined in a number of consecutive comparisons of the expected monitored signal with the monitored signal.

The specific component may comprise one of an emitter in the illumination arrangement and a detector of the light detection arrangement.

The processor unit may be configured to, if the reduced performance linked to a specific component is linked to a certain emitter of the illumination arrangement, generate a signal to the illumination arrangement for increasing the energy of light emitted from that emitter. Correspondingly, the processor unit may be configured to, if the reduced performance linked to a specific component is linked to a certain detector of the light detection arrangement, generate a signal to the light detection arrangement for increasing the output signal level of that detector.

The processor unit may be configured to determine the reduced performance in response to an operator-triggered event. Optionally or in addition, the processor unit may be configured to regularly, i.e. at certain time intervals, determine the reduced performance. An example of an operator-triggered event may be a function test, and an example of a certain time interval can be every 10:th second, once every hour, day or week, once every time the device is started etc. To save processing capacity and/or for saving energy, the reduced performance may be determined less frequent than the touch.

The processor unit may be configured to, if a reduced performance is determined, generate a signal calling for a certain operator-activity, such as calling for maintenance, cleaning of the touch surface, replacement of a certain component etc.

According to a second aspect the invention relates to a touch sensitive apparatus comprising: a light transmitting panel, which is defined by a touch surface on one side and by an opposed back surface on the opposite side, an illumination arrangement configured to introduce light into the panel for propagation by internal reflection between the touch surface and the back surface, a light detection arrangement configured to receive the light after propagation in the panel, and the device according to the first aspect of the invention.

According to a third aspect the invention relates to a method of identifying a reduced performance in a touch sensitive apparatus, the method comprising the steps of: introducing light into a panel of said touch sensitive apparatus in order to detect touch data for one or more objects in contact with said panel, detecting the light as it has passed through the panel and obtaining a monitored signal as a function of the energy of the detected light, reconstructing, based on the monitored signal, a two-dimensional attenuation field that represents an attenuation of the transmitted light on the touch surface, calculating an expected monitored signal based on the reconstructed attenuation field, and comparing the expected monitored signal with the monitored signal in order to determine a reduced performance of the touch sensitive apparatus.

According to fourth aspect the invention relates to a method of processing data from a touch sensitive apparatus, which apparatus comprises: a light transmitting panel, which is defined by a touch surface on one side and by an opposed back surface on the opposite side; an illumination arrangement configured to introduce light into the panel for propagation by internal reflection between the touch surface and the back surface; and a light detection arrangement configured to detect the light after propagation in the panel, wherein the method comprises: obtaining a monitored signal as a function of the energy of the light detected by the light detection arrangement, reconstructing, based on the monitored signal, a two-dimensional attenuation field representing an attenuation of the transmitted light on the touch surface, calculating an expected monitored signal based on the reconstructed attenuation field, and comparing the expected monitored signal with the monitored signal in order to determine a reduced performance of the touch sensitive apparatus.

The inventive methods may include any of the functionality implemented by the features described above in association with the inventive device and shares the corresponding advantages. For example, the method may include a number of steps corresponding to the above described operations of the processor unit.

According to a fifth aspect of the invention a computer-readable medium is provided, which stores processing instructions that, when executed by a processor, performs any of the above described methods.

Still other objectives, features, aspects and advantages of the invention will appear from the following detailed description, from the attached claims and from the drawings.

### BRIEF DESCRIPTION OF THE DRAWINGS

Embodiments of the invention will now be described, by way of example, with reference to the accompanying schematic drawings, of which

FIG. 1 is a top plan view of an embodiment of a touch sensitive apparatus including a touch surface,

FIG. 2 is a cross sectional view of the apparatus in FIG. 1,

FIG. 3 is a top plan view of the embodiment of the apparatus in FIG. 1, where propagation of light is illustrated in further detail,

FIG. 4 is a 3D plot of an estimated attenuation field,

FIG. 5a-5c are schematic representations of signal fields indicating distinct sub-signal values for specific emitter-detector pairs,

FIG. 6 is a flow diagram illustrating an embodiment of a method for identifying a reduced performance of the apparatus in FIG. 1, and

FIG. 7 is a perspective view of a set of neighboring basis functions used for representing an attenuation field.

### DETAILED DESCRIPTION

Below, embodiments of the invention will be described in detail with reference to a touch sensitive apparatus. However, according to a first aspect, the invention relates to a device for processing data from such a touch sensitive apparatus. In order to keep the description as coherent as possible, these embodiments of the invention are not described in detail in here. For a skilled person it is obvious how a device for processing data may be configured from the general description of a touch sensitive apparatus below.

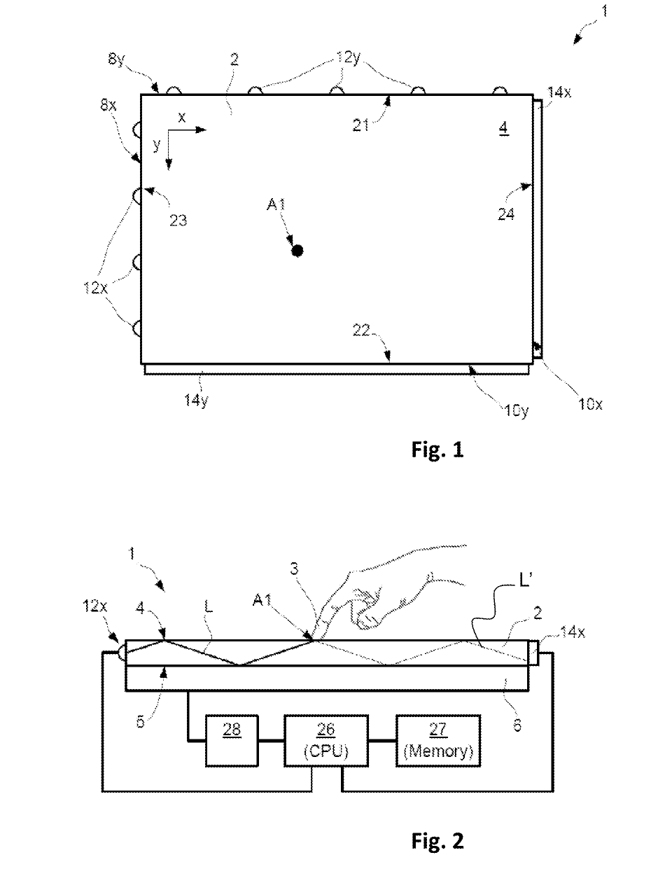

With reference to FIG. 1 and FIG. 2, an embodiment of a touch sensitive apparatus 1 is illustrated. The touch sensitive apparatus 1 (also denoted “FTIR system” herein) is adapted to determine a location A1 of one object 3, or several objects, that touches a touch surface 4. The touch sensitive apparatus 1 includes a light transmissive panel 2 that may be planar or curved. The panel 2 is defined by the touch surface 4 on one side and by an opposite back surface 5 opposite and generally parallel with the touch surface 4. The panel 2 is configured to allow light L to propagate inside the panel 2 by internal reflection between the touch surface 4 and the opposite back surface 5.

In FIG. 1, a Cartesian coordinate system has been introduced, with the x-axis parallel to a first side 21 and to a second side 22 of the panel 2 while the y-axis is parallel to a third side 23 and to a fourth side 24 of the panel 2. The exemplified panel 2 has a rectangular shape but may just as well be e.g. circular, elliptical, triangular or polygonal, and another coordinate system such as a polar, elliptic or parabolic coordinate system may be used for describing the location A1 of the object 3 on the panel 2.

Generally, the panel 2 may be made of any material that transmits a sufficient amount of light in the relevant wavelength range to permit a sensible measurement of transmitted energy. Such material includes glass and polycarbonates. The panel 2 is typically defined by a circumferential edge portion such as by the sides 21-24, which may or may not be perpendicular to the touch and back surfaces 4, 5.

As indicated in FIG. 2, the apparatus 1 includes an interface device 6 for providing a graphical user interface (GUI) within at least part of the touch surface 4. The interface device 6 may be in the form of a substrate with a fixed image that is arranged over, under or within the panel 2. Alternatively, the interface device 6 may be a screen arranged underneath or inside the apparatus 1, or a projector arranged underneath or above the apparatus 1 to project an image onto the panel 2. Such an interface device 6 may provide a dynamic GUI, similar to the GUI provided by a computer screen. The interface device 6 is controlled by a GUI controller 28 that may determine where graphical objects of the GUI shall be located, for example by using coordinates corresponding to the coordinates for describing the interaction A1. The GUI controller 28 may be connected to and/or be implemented in the processor unit 26. As will be described in the following, the processor unit 26 implements a method for determining the location of one or more objects on the touch surface 4, by operating on signal(s) that represent a signal property, such as energy, of transmitted light through the panel 2. The processor unit 26 may also implement a process for identifying a reduced performance of the apparatus 1, to be described further below.

The method for determining the location and the process for identifying a reduced performance may be implemented as processing instructions which are stored on a memory unit 27 connected to the processor unit 26 and which are executed by the processor unit 26. Alternatively, the process for identifying a reduced performance may be implemented in a separate device (e.g. comprising a processor unit and memory unit) which is adapted for connection to the touch-sensitive apparatus 1.

The memory unit 27 may comprise a computer-readable medium that stores the processing instructions. It is also conceivable that the processing instructions are loaded into the touch-sensitive apparatus 1 for providing the functionality of identifying a reduced performance.

Now, with reference to FIG. 1, the light L for detecting objects on the panel 2 may be coupled into the panel 2 via one or more incoupling sites. For example, the light L may be coupled into (be introduced into) the panel 2 via a first incoupling site 8x at the third side 23 of the panel 2 and via a second incoupling site 8y at the first side 21 of the panel 2.

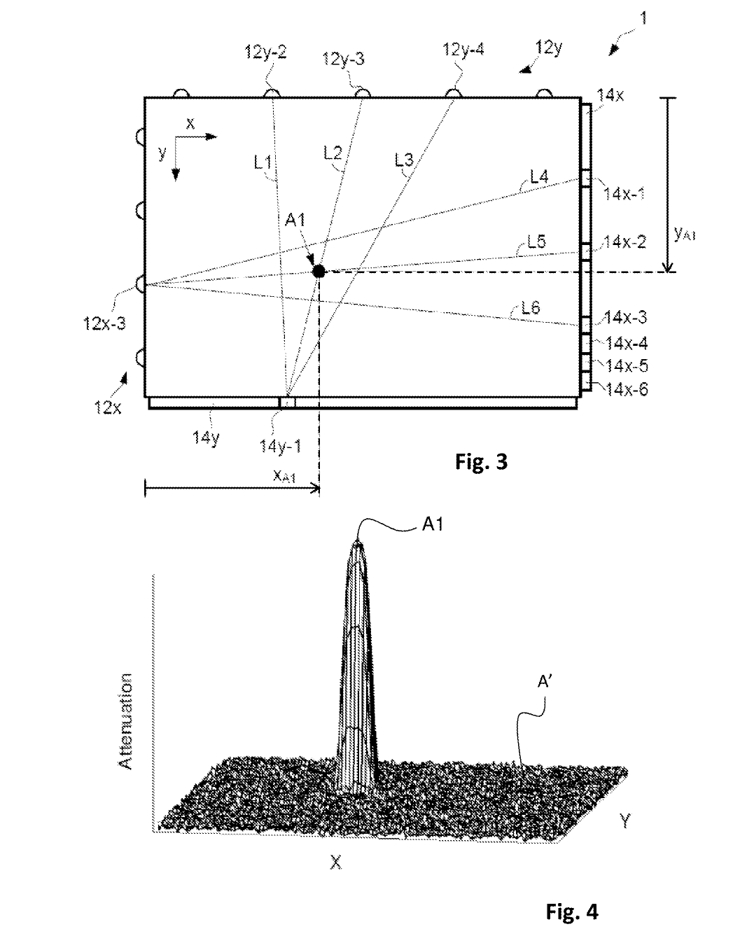

With further reference to FIG. 3, a first part 12x of an illumination arrangement is arranged at the first incoupling site 8x and a second part 12y of the illumination arrangement is arranged at the second incoupling site 8y. Each of the parts 12x, 12y comprises a number of light emitters such as light emitter 12x-3 of the first part 12x of the illumination arrangement and light emitters 12y-2, 12y-3, 12y-4 of the second part 12y of the illumination arrangement.

The light emitters 12x-3, 12y-2, 12y-3, 12y-4 introduce light in form of a respective diverging beam (diverging in the plane of the panel 2) that propagates in a direction towards a first outcoupling site 10x at the fourth side 24 of the panel 2 and a second outcoupling site 10y at the second side 22 of the panel 2 where the light is received (coupled out). A first part 14x of a light detection arrangement is arranged at the first outcoupling site 10x and a second part 14y of a light detection arrangement is arranged at the second outcoupling site 10y. The parts 14x, 14y of the light detection arrangement measure the energy of the light received at the respective outcoupling site 10x, 10y.

The light emitters may be any type of device capable of emitting light in a desired wavelength range, for example a diode laser, a VCSEL (vertical-cavity surface-emitting laser), or alternatively a LED (light-emitting diode), an incandescent lamp, a halogen lamp, etc.

Each of the parts 14x, 14y of the light detection arrangement comprises a number of light detectors arranged in sequence, such as light detectors 14x-1 to 14x-6 of the first part 14x and light detector 14y-1 of the second part 14y. Although not illustrated, the light detection arrangement comprises light detectors that cover the full length of the outcoupling sites 10x, 10y, which basically corresponds to the full lengths of the fourth side 24 and the second side 22. This may mean that light detectors are arranged adjacent each other, such as the illustrated light detectors 14x-3 to 14x-6.

The light detectors may be any type of device capable of detecting the energy of light emitted by the illumination arrangement 12x, 12y, such as a photodetector, an optical detector, a photoresistor, a photovoltaic cell, a photodiode, a reverse-biased LED acting as photodiode, a charge-coupled device (CCD) etc.

The light in the form of a diverging beam emitted from the light emitters 12x-3, 12y-2, 12y-3, 12y-4 is received by a certain number of light detectors of the first part 14x and/or the second part 14y of the light detection arrangement. Exactly which of the light detectors that receives light from a certain light emitter depends on the location of the detectors and emitters and on the beam divergence (angular measurement) of the emitted light. For example, as illustrated by paths of light L1-L6, light emitted from each of the light emitters 12y-2, 12y-3, 12y-4 may propagate towards and be received by the light detector 14y-1, while light emitted from the light emitter 12x-3 may propagate towards and be received by each of the light detectors 14x-1, 14x-2, 14x-3.

Of course, depending on beam divergence and on the location of the emitters and detectors, light may pass between other sets of emitters/detectors, even though this is not illustrated.

Each of the light emitters may (but need not) emit multiplexed light, for example by using wavelength-division multiplexing or pulse-code multiplexing, such that it is possible to identify unique paths of light from a certain light emitter to a certain light detector. For example, if wavelength-division multiplexing is used, light emitter 12x-3 may emit light with a wavelength of λx-3, light emitter 12y-2 may emit light with a wavelength of λy-2, light emitter 12y-3 may emit light with a wavelength of λy-3 and light emitter 12y-4 may emit light with a wavelength of λy-4. Each of the light detectors 14x-1, 14x-2, 14x-3 and 14y-1 may detect and differentiate light at different wavelengths and may generate a signal representing the energy of the received light for a certain wavelength. In this case, any suitable known type of light emitters and light detectors capable of emitting respectively detecting light at a certain wavelength may be used. However, the wavelengths are advantageously within the infrared or visible wavelength region.

In the above-mentioned pulse coding multiplexing, the emitters are controlled to embed an identifying code in the emitted light, such that the measured energy may be separated, e.g. by the processing unit, into energy values for different detection lines. Such a technique is disclosed in WO2010/064983, which is incorporated herein by reference.

In this context, a path of light may be referred to as a detection line, where, using FIG. 3 as an example, each detection line L1-L6 comprises a respective (unique) path of light from an emitter to a detector.

The energy of the light registered by the light detection arrangement 14x, 14y is continuously or intermittently received by the processor unit (CPU) 26, which monitors a signal S. More specifically, in the exemplified embodiment, the monitored signal S includes a number of sub-signals S_{L1}, S_{L2}, S_{L3}, S_{L4}, S_{L5}, S_{L6}, where each sub-signal S_{Li} is given as a function of the transmitted energy between a certain light emitter and a certain light detector, such that the sub-signals S_{L1}-S_{L6} correspond to a respective, unique detection line Li of the detection lines L1-L6. The monitored signal S may thus be seen as an aggregation of the sub-signals S_{L1}-S_{L6}. Operations on the monitored signal S described below may be performed on one or more of the sub-signals S_{L1}-S_{L6} of the monitored signal S. It is also conceivable, in certain implementations, that some or all operations are performed directly on the monitored (aggregated) signal S.

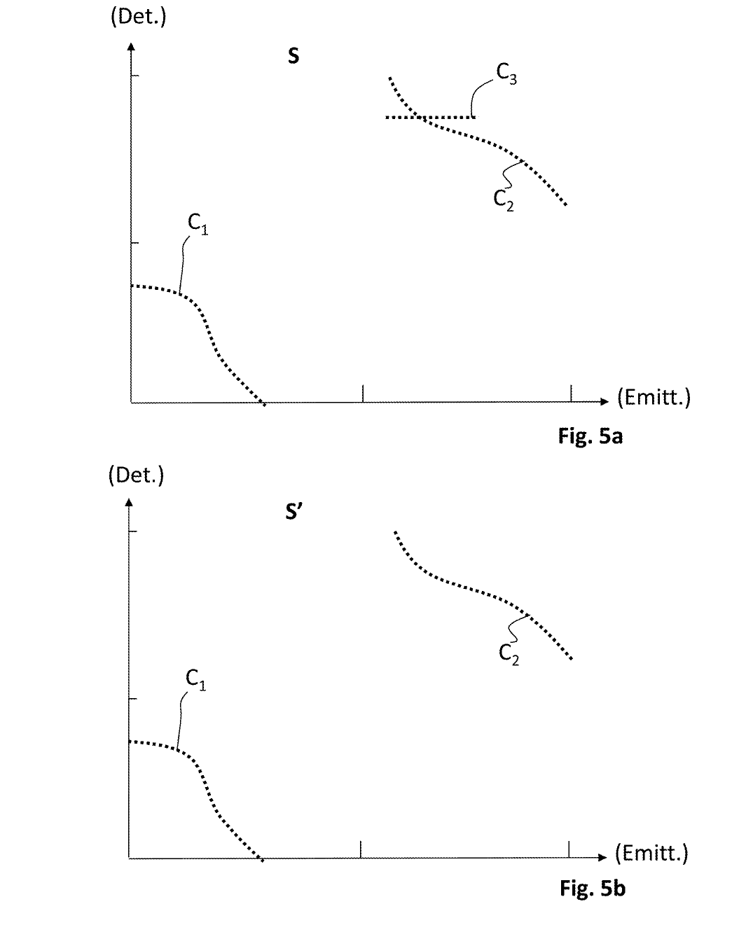

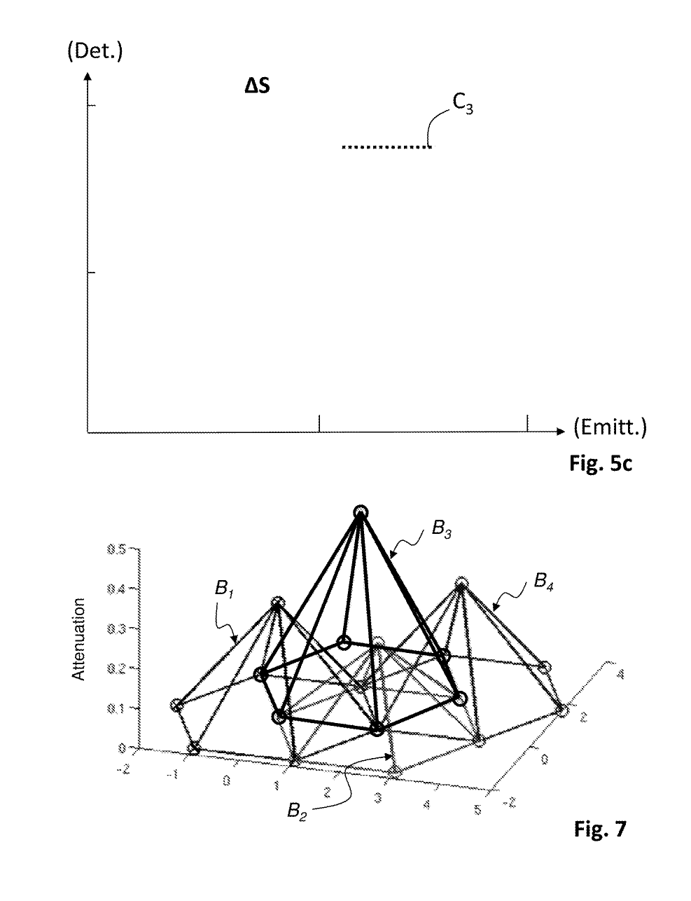

The aggregated signal S may be described as a vector with one element for each sub-signal S_{L1}-S_{L6}. Another way of representing the aggregated signal S is described further below with reference to FIGS. 5a-5c.

Typically the sub-signals S_{L1}-S_{L6} are obtained over the same period of time, or at close intervals, such that the vector corresponds to a single measuring instant. In an alternative to the above-mentioned multiplexing techniques, the emitters may be activated one at the time, or in selected groups, such that the detectors will detect and register light from only one emitter at a time. In such an arrangement all emitters could be activated intermittently e.g. 100 times per second, such that the energy values for different detection lines are not registered at the exact same time by the same detector, but so close in time that any movement of the object during that time would be negligible. As used herein, the time period required for acquiring all relevant sub-signals, and thus for populating the vector, is denoted a “sensing instance”.

Another way of producing detection lines is to sweep beams of light inside the panel in a determined manner, wherein detectors are arranged at appropriate locations to detect the energy for various detection lines. For the purpose of this invention, the manner of producing detection lines and the signal S is not important. The method and apparatus according to the invention may easily be adapted to different manners of generating the signal, all within the scope of the claims, regardless of the illumination arrangement or light detection arrangement used. For the purpose of exemplifying such alternative illumination and detection arrangements, patent publications U.S. Pat. No. 6,972,753, U.S. Pat. No. 7,432,893, US2006/0114237, US2007/0075648, WO2009/048365, WO2010/006882, WO2010/006884, WO2010/006885, WO2010/006886, WO2010/064983 and WO2010/134865 are incorporated by reference.

The processor unit 26 is connected to the light detection arrangement 14x, 14y such that the monitored signal/sub-signals S, S_{L1}-S_{L6}, may be obtained and monitored by the processor unit 26. Also, the processor unit 26 is connected to the illumination arrangement 12x, 12y for initiating and controlling the introduction of light into the panel 2.

As illustrated in FIG. 2, the light L is allowed to propagate inside the panel 2 by internal reflection between the touch surface 4 and the back surface 5. As is known within the field of touch-sensitive panels, the internal reflection is typically caused by total internal reflection (TIR) which is sustained as long as the light L is emitted into the panel at an angle to the normal of the panel which is larger than the critical angle at a light-injection site of the panel.

When the propagating light L impinges on the touch surface 4, the touch surface 4 allows the light L to interact with the touching object 3, and at the location A1 of the touch, part of the light L may be scattered by the object 3, part of the light L may be absorbed by the object 3 and part of the light L may continue to propagate by internal reflection. The scattering and the absorption of light are in combination referred to as attenuation. In FIG. 2, this is illustrated in that the attenuated light L′, after reflection below the object 3 is illustrated by a thinner line (L′). Hence, the detected light energy for that detection line Li is lower than it would have been if the light had not been attenuated.

The touch between the object 3 and the touch surface 4 is typically defined by the area of contact between the object 3 and the touch surface 4, and results in the mentioned attenuation of the propagating light L. The interaction between the object 3 and the light L generally involves so-called frustrated total internal reflection (FTIR), in which energy of the light L is dissipated into the object 3 from an evanescent wave formed by the propagating light L, provided that the object 3 has a higher refractive index than the material surrounding the touch surface 4 and is placed within less than several wavelengths distance from the touch surface 4.

More specifically, light propagating along a certain detection line is attenuated when the object 3 touches the touch surface 4. For example, for the detection lines of FIG. 3, light propagating along detection lines L2 and L5 is attenuated when the location A1 of the object 3 is positioned as illustrated. This means that the energy of light received by the light detector 14y-1 and being emitted by light emitter 12y-3 is reduced due to the attenuation. In a similar manner, the energy of light emitted by light emitter 12x-3 towards the light detector 14x-2 will also be attenuated along its path. It will therefore have a reduced energy when it is received by the light detector 14x-2.

From this follows that, when light along detection lines L2 and L5 is attenuated, the sub-signals S_{L2} and S_{L5} associated with attenuation lines L2 and L5 exhibit changes in signal levels. Depending on the functional relation between measured light energy and monitored signal S, the signal levels of sub-signals S_{L2}, S_{L5} may be either reduced or increased when attenuation occurs along the detection lines L2, L5.

There are many ways of generating the monitored signal S and the sub-signals S_{Li}. Generally, it may however be said that the signal represents the attenuation of the light transmitted in the panel. In the following example, each sub-signal is calculated from the following equation:

$${S}_{Li} = - log ( \frac{{E}_{i}}{{E}_{i \text{-} ref}} )$$

In this example, a specific sub-signal S_{Li} is dependent on the current light energy Eᵢ for a corresponding detection line Li. For each current light energy Eᵢ there is a reference light energy E_{ire f}. The light energy Eᵢ corresponds to the energy of the detected light, and the reference value E_{i-ref} may be chosen to correspond to the energy of an unattenuated detection line Li. From the equation follows that S_{Li} will be 0 or close to 0 as long as the current light energy Eᵢ is equal or almost equal to the reference value E_{i-ref}, e.g. as long as the light is not attenuated. Further, it follows from the equation that when the light is attenuated, such that Eᵢ becomes smaller than E_{i-ref}, S_{Li} will obtain a positive value due to the minus sign in the equation.

Thus, for a monitored signal S where none of the detection lines are attenuated, all sub-signals S_{Li} will have a value that is close to 0. For a typical monitored signal S where a single object is present on the point A1 on the touch surface, there will be a number of positive values for all detection lines that passes that point A1, whereas all other values are 0 or close to 0. Hence, in the example shown in FIG. 3, the sub-signals corresponding to the detection lines L2 and L5 will have positive values, whereas all other values are 0 or close to 0. As indicated above there may be a redundancy of detection lines such that a plurality of detection lines passes through the point A1 where the object is located.

The determination of the location of touches on the touch surface 4 may involve operating a reconstruction function on the aggregated signal S or on all or some of the sub-signals S_{Li}, so as to calculate a so-called attenuation field A′. The reconstructed attenuation field A′ may be seen as a two-dimensional distribution of attenuation values across the touch surface 4 (or a relevant part of the touch surface). Each attenuation value, e.g. in the range of 0-1, represents a local attenuation of energy in a specific position or within a reconstruction cell (pixel) on the touch surface. The attenuation field A′ may e.g. be represented by a predetermined grid of partially overlapping (interpolating) basis functions (cf. FIG. 7) which are assigned an individual attenuation value, or by a matrix of attenuation values for individual reconstruction cells. In fact, the reconstruction cells may actually be regarded as a grid of non-overlapping basis functions with a top hat distribution.

Any available reconstruction algorithm/function may be used, including tomographic reconstruction methods such as Filtered Back Projection, FFT-based algorithms, ART (Algebraic Reconstruction Technique), SART (Simultaneous Algebraic Reconstruction Technique), etc. Alternatively, the reconstruction function may generate the attenuation field by adapting one or more basis functions to the sub-signals and/or by statistical methods such as Bayesian inversion. Examples of such reconstruction algorithms designed for use in touch determination are found in patent applications WO 2010/006883, WO2009/077962, WO2011/049511, WO2011/139213, PCT/SE2011/051201 filed on Oct. 7, 2011, and US61/552024 filed on Oct. 27, 2011, all of which are incorporated herein by reference. Conventional reconstruction methods are found in the mathematical literature, e.g. “The Mathematics of Computerized Tomography” by Natterer, and “Principles of Computerized Tomographic Imaging” by Kak and Slaney.

On a general level, the reconstruction of the attenuation field A′ may be represented as a function F of the aggregated signal S, i.e. by the equation:

A′=F(S).

An example of a reconstructed attenuation field A′ is given in the 3D plot of FIG. 4, which shows reconstructed attenuation values in the XY coordinate system of the touch surface 4. In this example, a peak in the attenuation field is caused by the single object in contact with the touch surface at location A1.

FIG. 4 is an example of a full reconstruction of the attenuation field A′, i.e. an estimation of all attenuation values within the whole extent of the touch surface 4. In an alternative embodiment, the attenuation field is only reconstructed within one or more subareas of the touch surface. The subareas may be identified by analyzing intersections of attenuation paths across the touch surface, based on the above-mentioned sub-signals. A technique for identifying such subareas is further disclosed in WO2011/049513 which is incorporated herein by reference.

The reconstructed attenuation field A′ may be processed for identification of touch-related features and extraction of touch data (“touch data extraction”), and for identifying a fault condition of the FTIR system (“fault detection”).

The touch data extraction may utilize any known technique for isolating true (actual) touch points within the attenuation field. For example, ordinary blob detection and tracking techniques may be used for finding the actual touch points. In one embodiment, a threshold is first applied to the attenuation field, to remove noise. Any areas with attenuation values that exceed the threshold, may be further processed to find the center and shape by fitting for instance a two-dimensional second-order polynomial or a Gaussian bell shape to the attenuation values, or by finding the ellipse of inertia of the attenuation values. There are also numerous other techniques as is well known in the art, such as clustering algorithms, edge detection algorithms, etc. Any available touch data may be extracted, including but not limited to x,y coordinates, areas, shapes and/or pressure of the touch points.

The fault detection is based on the insight that it is possible to compute an “expected signal” S′, which is an estimate of the monitored signal S, by doing the reconstruction “backwards” based on the reconstructed attenuation field A′. The computation of the expected signal S′ is done in such a way that signal features in the monitored signal S that are due to touch interaction (or contamination) are also present in the expected signal S′ with similar amplitude, whereas signal features in the monitored signal S that are due to faults are not present in the expected signal S′, or at least suppressed in the expected signal S′ compared to the monitored signal S. Thus, looking at the difference S-S′, any signal features caused by touch interaction should have relatively low amplitude, while features caused by faults should be relatively strong.

Thus, in the fault detection, a function F′ is operated on the reconstructed attenuation field A′ to calculate the expected signal S′:

S′=F′(A).

It is to be understood that the expected signal S′ may comprise a number of expected sub-signals S′_{Li}, each corresponding to a respective detection line Li.

In one example, explained in more detail further below, the function F′ is implemented to evaluate projections along the individual detection lines through the reconstructed attenuation field A′. However, it should be understood that there are many alternative ways of implementing the function F′, which need not be based on projections. For simplicity, the function F′ is generally denoted “projection function” herein, be it based on projections or not.

There are at least two reasons why the combined use of functions, S′=F′(F(S)), may map signal features from touches and faults, respectively, in the monitored signal S differently to signal features in the estimated signal S′. One is that fault features are generally ‘sharp’ or discrete in the monitored signal S, since they contain more high-frequency components than touch features. The application of the reconstruction function F and the function F′ on the monitored signal S has a low-pass filtering effect, meaning that the amplitude of signal features from faults will be reduced in the estimated signal S′ compared to the monitored signal S. The second reason is that faults in the monitored signal S that are caused by a malfunctioning component will sometimes show up as a peak in the reconstruction, the peak being at the location of the component. However, typically this location is slightly outside the touch area and is not included in the reconstructed attenuation field A′. Thus, the peak will not contribute to the estimated signal S′, and the detection lines in the expected signal S′ going to or from the component will contain little contribution (or none at all) from the fault.

In one embodiment of the fault detection, a comparative signal ΔS is calculated from the difference between the monitored signal S and the expected signal S′. This comparative signal ΔS may be calculated by subtracting each expected sub-signal S′_{Li} from each corresponding monitored sub-signal S_{Li}. By means of this subtracting method a number of comparative sub-signals ΔS_{Li} will be generated. These comparative sub-signals ΔS_{Li} may subsequently be compared to specific threshold values THRᵢ, wherein comparative sub-signals ΔS_{Li} that fall above or below (depending on implementation) the corresponding threshold values THRᵢ may indicate an erroneous signal.

Optionally, a weight factor may be applied to one or both of the monitored and expected signals S, S′ before the subtraction: ΔS=w₁·S−w₂·S′, where the weight factors w₁, w₂ may be set globally or for individual detection lines. Generally, it is also conceivable that one or both of the monitored and expected signals S, S′ are pre-processed before the comparison to further emphasize relevant differences.

In a variant, corresponding detection lines in ΔS may be grouped by point of failure, such that the detection results in identification of one or more malfunctioning components rather than faulty detection lines. In the example of FIG. 3, based on the geometric pattern of detection lines, a malfunction of the emitter 12x-3 is known to affect detection lines L4-L6. In a similar manner, a malfunctioning detector 14y-1 is known to affect detection lines L1-L3. With this in mind, the values of the comparative signal ΔS corresponding to detection lines L4-L6 and L1-L3 may be aggregated into a respective component parameter value. The component parameter value may e.g. be given as a (weighted) sum of absolute differences, optionally normalized by the number of detection lines included in the respective sum. By comparing the component parameter value to a threshold, the system may directly identify a malfunctioning component.

In this manner conclusions may be drawn as to the origin of the fault condition and measures may be taken to adapt control parameters in response to the detected faults. If, for example, one detector indicates attenuation for every associated detection line Li it may be concluded that that particular detector has a reduced detection capacity. If the detected fault is very large, e.g. if the detected light energy is close to 0 for each detection line, it may indicate that the particular detector is not functioning at all and should be disregarded in the reconstruction of the attenuation field A′ in the current or a forthcoming sensing instance. Alternatively, it may be possible to increase the gain or otherwise amplify the output of the particular detector.

The same logic may of course be used for detection lines of a specific emitter. Hence, if all detection lines of a specific emitter indicate an almost total attenuation it may be concluded that that specific emitter is not working such that it may be disregarded when reconstructing the attenuation field A′.

If instead a small but distinct fault is detected for each detection line of a particular detector or emitter, it may indicate that the particular emitter or detector has a reduced performance, whereby the corresponding reference light energy values E_{i-ref} may be changed to counteract the reduced performance. Also, when it is indicated that an emitter has a reduced performance, it may be possible to increase the luminance of that emitter to counteract its reduced performance.

To further illustrate the concept of grouping the signals by point of failure, FIGS. 5a-5c are “system fields” for the signals S, S′ and ΔS, respectively. Each system field is a two-dimensional (2D) pattern or diagram of signal values, where the X-axis indicates distinctive emitters and the Y-axis indicates distinctive detectors. Thus, the signal value S_{Li}, S′_{Li}, ΔS_{Li} of a detection line Li that extends between a specific emitter-detector pair has a distinct location in each system field. It is understood that the signal values may attain a range of values that reflect the magnitude of attenuation across the corresponding detection lines Li, e.g. with values spanning a signal range of 0-1.

In the example of FIGS. 5a-5c, dotted lines are included to indicate structures of enhanced attenuation (elevated signal values) for a set of sub-signals S_{Li}, S′_{Li} and ΔS_{Li} acquired and generated during a sensing instance.

In the example of FIG. 5a, a single object on the touch surface gives rise to two distinct curves C₁ and C₂ in the system field of the monitored signal S. The shape of the curves vary with the location of a touch, but is also specific for the shape of the touch surface and the distribution of detectors and emitters around the same. Also visible in FIG. 5a is a horizontal structure C₃, i.e. relating to only one detector. This structure C₃ may be caused by a malfunction of this detector. In FIG. 5b, which represents the system field of the expected signal S′, the horizontal structure C₃ does not appear. Thus, FIG. 5b illustrates the fundamental property, described above, that the combined use of functions F, F′ serves to separate touch features from fault features in the monitored signal S, since these features are mapped differently to signal features in the estimated signal S′.

FIG. 5c illustrates the system field of the comparative signal ΔS, resulting from a comparison of the monitored signal S with the expected signal S′. Since the comparative signal ΔS contains the structure C₃, it may be concluded that a fault exists. It may be noted that a faulty emitter would appear as a vertical structure in FIG. 5c.

Thus, a faulty component may e.g. be identified by processing the signal values ΔS_{Li} so as to generate the component parameter value as an aggregated signal value for each row and/or column in the system field of ΔS, e.g. by summing or averaging the signal values in each row/column, and by comparing the aggregated signal values to a threshold or limit value. A defect or malfunctioning detector will show up as an elevated aggregated signal value for a particular row, and a defect or malfunctioning emitter will show up as an elevated aggregated signal value for a particular column.

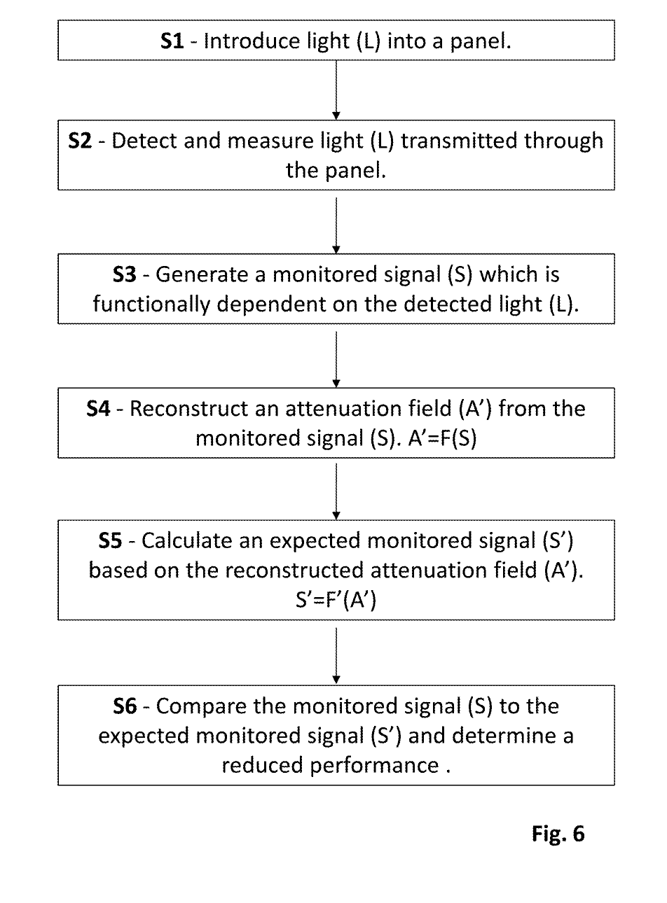

In one embodiment, the process for fault detection may be described in six consecutive steps. These steps are illustrated in FIG. 6. In a first step (S1), light is introduced into the panel, e.g. from a first side of the panel. In a second step (S2), the light is detected and measured, e.g. on the opposite side of the panel, such that the transmitted light for each detection line Li is measured. In a third step (S3), a monitored signal (or monitoring signal) S is generated, e.g. to represent the attenuation for each detection line Li of the light through the panel. In a fourth step (S4), an attenuation field A′ is reconstructed by operating a reconstruction function F on the monitored signal S. In parallel to the illustrated process, the reconstructed attenuation field A′ may be analyzed in order to determine any touch points, e.g. A1, on the touch surface. In a fifth step (S5), an expected monitored signal S′ is calculated by operating a projection function F′ on the reconstructed attenuation field A′. In a sixth step (S6), the expected monitored signal S′ is compared to the monitored signal S, for the purpose of identifying faulty detection lines and/or points of failure. If there is a faulty component in the FTIR system, there will be a notable difference between the signal values of the monitored signal and expected monitored signal for one or more detection lines.

The projection function F′ may be defined to yield a signal value for each detection line, e.g. by evaluating a line integral of the attenuation values along the detection line. For example, if the attenuation field is defined by cells, and each cell has a single attenuation value within its extent, the expected signal value S′_{Li} of a detection line Li may be generated based on the function:

S′_{Li}=Σ_{Li}(aⱼ·Δs_{i,j}),

where aⱼ is the attenuation value of cell j, Δs_{i,j} is the length of the intersection between cell j and detection line Li, and the expected signal value S′_{Li} corresponds to the total attenuation along detection line Li.

If the attenuation field instead is defined by interpolating basis functions, as exemplified in FIG. 7, the expected signal values for the detection lines may be generated based on the following equation:

S′_{Li}=Σ_{Li}(aⱼ·∫Bⱼ(s)ds),

where aⱼ is the attenuation value of the basis function Bⱼ, and ∫Bⱼ(s) cis is the line integral along the intersection of basis function Bⱼ with detection line Li.

FIG. 7 illustrates an example of four basis functions B₁-B₄ shaped as pyramids with a hexagonal base that are arranged in a hexagonal grid, with the center point of the base coinciding with a grid point, and the corner points of the base coinciding with the neighboring grid points. Each basis function B₁-B₄ has an individual height, given by the attenuation value aⱼ. The overlapping portions of the neighboring basis functions B₁-B₄ are added by linear interpolation to represent the attenuation field. FIG. 7 is only intended as an example, and any type of basis function, interpolating or not, may be used.

As used herein, a “line integral” denotes a function that is evaluated to generate a measure of the area of a slice through the basis function, where the slice may be formed by the intersection between the detection line and the basis function. This line integral may be generated as an analytic integration of the slice, or an approximation thereof. Such an approximation may involve calculating the area based on a plurality of data points that define the slice, typically at least 3 data points. Each such data point defines a value of the basis function at a specific location within the basis function.

In all of these embodiments, the projection function F′ involves a summation over all detection lines, so as to calculate the sum of products/line integrals for each detection line. If there are O(n) emitters and O(n) detectors, the number of pixels or basis functions is typically O(n²). This implies that evaluating the projection function F′ for the entire attenuation field A′, including all cells/basis functions, is an O(n⁴) operation.

It should be noted that the intersections between detection lines and cells/basis functions are known parameters and are typically available in the form of pre-computed data. Thereby, S′=F′(A′) may be calculated by scaling the pre-computed data by the attenuation values aⱼ.

The skilled person also realizes that other projection functions F′ may be used to obtain the expected signal S′.

In one example, the projection function F′ is evaluated by, for each detection line, identifying the intersected cells/basis functions (e.g. by means of a table), and calculating a contribution to the expected signal value of the detection line based on the attenuation value of each intersected cell/basis function. In another example, the projection function F′ is evaluated by, for each cell/basis function, identifying the intersecting detection lines (e.g. by means of a table), and calculating a contribution to the expected signal value for each intersecting detection line based on the attenuation value of the cell/basis function. Both of these evaluations may be implemented as O(n³) operations. Further performance improvement may be achieved by only evaluating the projection function F′ for those cells/basis functions that have a significant attenuation in the reconstructed attenuation field A′, e.g. cells/basis functions that have an attenuation that exceeds a predefined threshold.

The FTIR system typically operates in a repetitive sequence of steps, or sensing instances, where each sensing instance may involve the steps of:
a) generating momentary values of the monitored signal S based on energy readings from the detectors,
b) generating the reconstructed attenuation field A′ based on the momentary values, via A′=F(S),
c) processing the reconstructed attenuation field A′ for determination of touch data, and
d) outputting the touch data.

The fault detection according to the invention may be executed during each sensing instance, or during selected sensing instances, such as e.g. once every 10 or 100 sensing instances.

Based on the output of the fault detection, the processing unit (26 in FIG. 2) may take measures to recalculate the attenuation field from the original monitored signal S, but without including the sub-signal(s) corresponding to the malfunctioning component/detection line. Another measure would be to exclude the sub-signal(s) from future measurements/reconstructions and/or to notify the malfunction to the user/operator of the FTIR system. By means of the inventive fault detection, unexpected results may be detected and analyzed, such that the operation of the apparatus will be continuously optimized without having to interrupt the determining of touches on the touch panel.

Also, as is obvious to a person skilled in the art, once a fault has been detected the operation may be adapted in many ways. Thus, a main object of this invention is to find a way to continuously track faults and defects, whereupon the correction of the faults may be performed in many different manners.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

For example, the monitored signal S may be given in other formats, e.g. transmission (e.g. given by light energy normalized by reference light energy), attenuation (e.g. given by 1—transmission), energy difference (e.g. given by the difference between light energy and reference light energy), or logarithm of attenuation or energy difference. As used hereinabove, a “logarithm” is intended to also encompass functions approximating a true logarithmic function, in any base. In another variant, the monitored signal S may be directly given by the measured light energy. Furthermore, the monitored signal S may have any sign.

As used herein, measurements of energy of light should be seen as equivalent to measurements of power, irradiance or intensity of light.

It also to be understood that the “attenuation field” and “attenuation values” may be given in any suitable format to represent the change in transmitted energy caused by touching object(s). In general terms, the attenuation field may be regarded as an “interaction field” or “interaction pattern” defined by “interaction values” that represent the local interaction with the propagating light on the touch surface. Thus, the terms “attenuation field” and “attenuation values” should be interpreted broadly.

1. A device for processing data from a touch sensitive apparatus, which apparatus comprises: a light transmitting panel, which is defined by a touch surface on one side and by an opposed back surface on the opposite side; an illumination arrangement configured to introduce light into the panel for propagation by internal reflection between the touch surface and the back surface; a light detection arrangement configured to receive the light after propagation in the panel, wherein the device comprises a processor unit configured to:
obtain a monitored signal which is functionally dependent on transmitted light detected by the light detection arrangement,
reconstruct, based on the monitored signal, a two-dimensional attenuation field representing an attenuation of the transmitted light on the touch surface,
calculate an expected monitored signal based on the reconstructed attenuation field, and
compare the expected monitored signal with the monitored signal in order to determine a reduced performance of the apparatus.

2. The device according to claim 1, wherein the processor unit is configured to reconstruct the attenuation field based on a grid of detection lines that each represents a path of light across the touch surface from the illumination arrangement to the light detection arrangement, wherein the monitored signal is comprised of a number of monitored sub-signals with a respective signal value that is functionally dependent on a measured light energy of a corresponding detection line, and wherein the attenuation field is reconstructed on basis of the signal values of the monitored sub-signals.

3. The device according to claim 2, wherein the processor unit is configured to reconstruct the attenuation field by tomographic reconstruction based on the signal values of the monitored sub-signals.

4. The device according to claim 2, wherein the processor unit is configured to calculate the expected monitored signal by evaluating a projection function that estimates an aggregated attenuation for at least part of the detection lines.

5. The device according to claim 2, wherein the processor unit is configured to calculate expected sub-signals for at least part of the detection lines based on the reconstructed attenuation field.

6. The device according to claim 5, wherein the attenuation field is defined by a set of basis functions on the touch surface, and a reconstructed attenuation value for each basis function, and wherein the processor unit is configured to calculate the expected sub-signals for at least part of the detection lines as a function of an intersection between the detection line and the basis functions.

7. The device according to claim 5, wherein the processor unit is configured to compare each expected sub-signal to the corresponding monitored sub-signal.

8. The device according to claim 7, wherein the processor unit is configured to produce a comparative sub-signal based on the comparison between the reconstructed sub-signals and the monitored sub-signals.

9. The device according to claim 8, wherein the processor unit is configured to alert if the comparative sub-signal passes a predetermined threshold value.

10. The device according to claim 8, wherein the processor unit is configured to group specific components of the illumination arrangement and/or the light detection arrangement to specific comparative sub-signals in order to link a reduced performance to a specific component.

11. The device according to claim 10, wherein the processor unit is configured to, if the reduced performance is linked to a specific component, disregard monitored sub-signals linked to the specific component in subsequent reconstructions of the attenuation field.

12. The device according to claim 11, wherein the processor unit is configured to disregard monitored sub-signals linked to the specific component only after the same reduced performance has been determined in a number of consecutive comparisons of the expected monitored signal with the monitored signal.

13. The device according to claim 10, wherein the specific component comprises one of an emitter in the illumination arrangement and a detector of the light detection arrangement.

14. The device according to claim 10, wherein the processor unit is configured to, if the reduced performance linked to a specific component is linked to a certain emitter of the illumination arrangement, generate a signal to the illumination arrangement for increasing the energy of light emitted from that emitter.

15. The device according to claim 1, wherein the processor unit is configured to determine the reduced performance in response to an operator-triggered event.

16. The device according to claim 1, wherein the processor unit is configured to, if a reduced performance is determined, generate a signal calling for a certain operator-activity.

17. A touch sensitive apparatus comprising:
a light transmitting panel, which is defined by a touch surface on one side and by an opposed back surface on the opposite side,
an illumination arrangement configured to introduce light into the panel for propagation by internal reflection between the touch surface and the back surface,
a light detection arrangement configured to receive the light after propagation in the panel, and
the device according to claim 1.

18. A method of identifying a reduced performance in a touch sensitive apparatus, the method comprising the steps of:
introducing light into a panel of said touch sensitive apparatus in order to detect touch data for one or more objects in contact with said panel,
detecting the light as it has passed through the panel and obtaining a monitored signal as a function of the energy of the detected light,
reconstructing, based on the monitored signal, a two-dimensional attenuation field that represents an attenuation of the transmitted light on the touch surface,
calculating an expected monitored signal based on the reconstructed attenuation field, and
comparing the expected monitored signal with the monitored signal in order to determine a reduced performance of the touch sensitive apparatus.

19. A method of processing data from a touch sensitive apparatus, which apparatus comprises: a light transmitting panel, which is defined by a touch surface on one side and by an opposed back surface on the opposite side; an illumination arrangement configured to introduce light into the panel for propagation by internal reflection between the touch surface and the back surface; and a light detection arrangement configured to detect the light after propagation in the panel, wherein the method comprises:
obtaining a monitored signal as a function of the energy of the light detected by the light detection arrangement,
reconstructing, based on the monitored signal, a two-dimensional attenuation field representing an attenuation of the transmitted light on the touch surface,
calculating an expected monitored signal based on the reconstructed attenuation field, and
comparing the expected monitored signal with the monitored signal in order to determine a reduced performance of the touch sensitive apparatus.

20. A computer-readable medium storing processing instructions that, when executed by a processor, performs the method according to claim 18.
